(19) United States
(12) Patent Application Publication
(10) Pub. No.: US 2025/0353667 A1
(43) Pub. Date: Nov. 20, 2025

(54) TRASH CAN WITH RELEASABLE STRAP

(71) Applicants: Lindi Lewis, Castle Rock, CO (US); Lance Lewis, Castle Rock, CO (US)

(72) Inventors: Lindi Lewis, Castle Rock, CO (US); Lance Lewis, Castle Rock, CO (US)

(21) Appl. No.: 18/890,007

(22) Filed: Sep. 19, 2024

Related U.S. Application Data
(60) Provisional application No. 63/647,952, filed on May 15, 2024.

(51) Int. Cl. B65F 1/16; B65F 1/14

(52) U.S. Cl. CPC B65F 1/1615; B65F 1/1473

(57) ABSTRACT

A trash can includes a main container and a lid pivotally coupled to the main container through a lid hinge. The trash can includes an elastic, releasable lid strap extending between the lid and the main container. The lid strap includes a strap lid portion that is releasably coupled to a strap housing portion. The strap lid portion has a first strap fastener in the form of a first hook and loop type fastener. The strap housing portion a second hook and loop type fastener. The first hook and loop type fastener is configured to releasably mate with or be coupled to the second hook and loop type fastener for a release or shearing between the first and second hook and loop type fasteners upon a select pulling or releasing.

### CROSS REFERENCE TO RELATED APPLICATIONS

Applicant claims the benefit of U.S. Provisional Patent Application Ser. No. 63/647,952 filed May 15, 2024 and entitled “Elastic Strap With Velcro Attachments To Secure Trash/recycle Can Lids. Brand Name Is Debris Daddy”.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present inventive concept relates to the field of a trash can, and specifically to a trash can having a releasable strap.

### Technology in the Field of the Invention

In today's society people dispose of trash waste or garbage by placing the trash within plastic bags and then placing the filled plastic bag within a garbage can or trash can, bin or receptacle. Alternatively, the trash, especially recyclable trash, is placed directly within the trash can without being bagged. In either case, the trash can is typically wheeled to the curb for pick up by a garbage truck that includes a mechanical arm that lifts the trash can over the sidewall or tailgate of the garbage truck, then inverts the trash can so that the trash may spill out of the trash can and into the trash storage area of the garbage truck. The mechanical arm then reverses directions to return the trash can to the curb. Because of the mechanical process involved in inverting the trash can, the lid cannot be locked in place as this would prevent the lid from opening once inverted.

A problem with this system is that people place the trash can at the curb the night before the early morning pick-up of the trash. As such, these trash cans sit at the curb for several hours before the trash within the trash can is collected. During this extended period of time the trash can may be tipped over or the lid of the trash can may be blown open by the wind or animals in the area looking for food. This may result in trash being spilled from the garbage and spread over the surrounding ground, thus requiring someone to pick-up the spilled trash.

Another problem is that as the garbage truck is in the process of inverting the trash can, the lid may open before the trash can is fully within the trash storage area of the garbage truck. Should this occur, a wind may cause the trash spilling from the trash can to be blown away prior to entering the garbage truck storage area. Again, this causes trash to be spilled onto the ground requiring someone to pick-up the trash.

Accordingly, a need exists for a trash can that prevents the trash from being accidentally spilled when sitting idle or while being emptied into a garbage truck. It is to the provision of such therefore that the present invention is primarily directed.

### BRIEF SUMMARY OF THE INVENTION

A trash can comprises a container having a bottom and sidewalls extending from the bottom to a top edge defining a top opening, a lid pivotally coupled to the container along a hinge, a strap lid portion coupled to the lid, the strap lid portion having a first strap fastener, and a strap housing portion coupled to the container, the strap housing portion having a second strap fastener, the second strap fastener being releasable couplable to the first strap fastener upon the application of a select release force being applied to the first strap fastener.

A trash can strap for use with a trash can having a housing and a lid coupled to the housing, the trash can strap comprises a strap lid portion having a looped first end and a second end distal the looped first end having a first strap fastener, and a strap housing portion having a looped first end and a second end distal the looped first end having a second strap fastener, the second strap fastener being releasable couplable to the first strap fastener upon the application of a select release force being applied to the first strap fastener.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of a trash can having a releasable strap embodying principles of the invention in a preferred form.

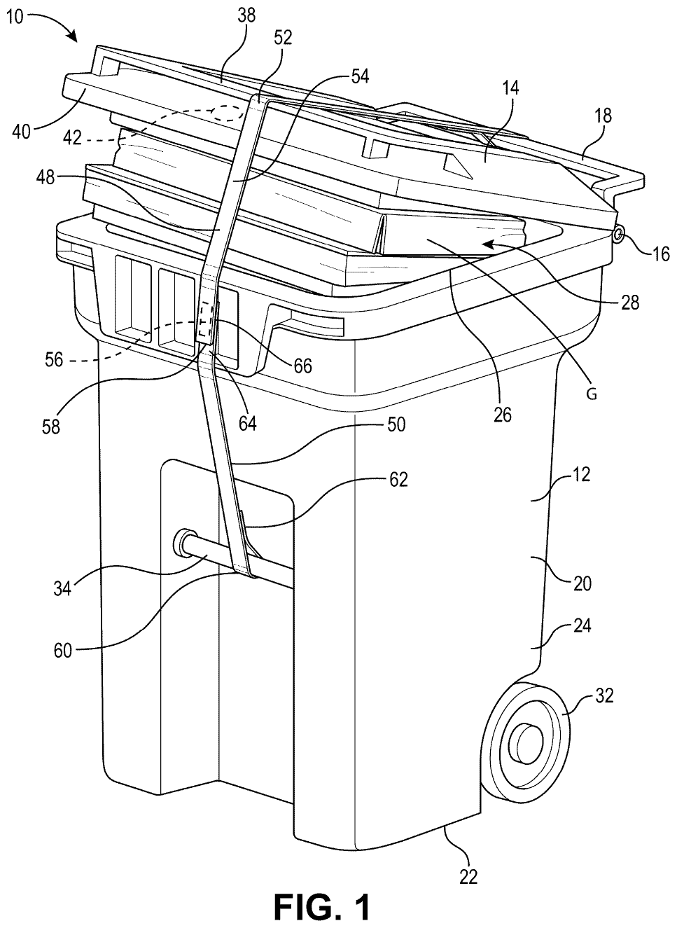

FIG. 2 is perspective view of the release strap shown in FIG. 1.

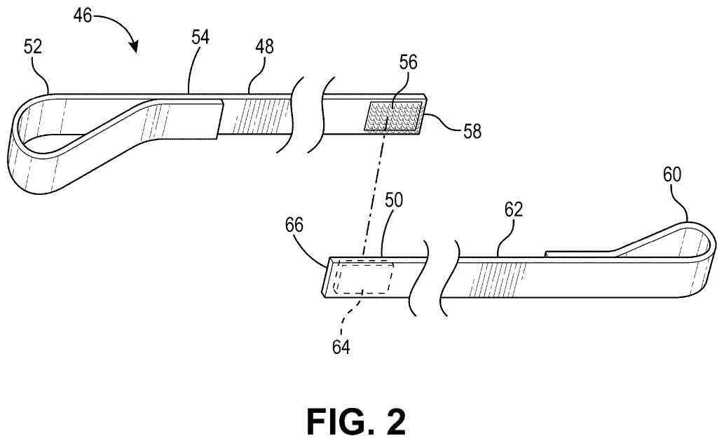

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

With reference next to the drawings, there is a shown a trash can, bin, or receptable 10 in a preferred form of the present invention, which may also be referenced as a garbage can, bin, receptacle or the like. Much of the trash can 10 is of conventional construction that includes a main container 12 and a cover or lid 14 pivotally coupled to the main container 12 through a lid hinge 16 located adjacent a rear push handle 18. The main container 12 has a large housing 20 with a bottom, bottom wall, or floor 22 and sidewalls 24 extending upwardly from the bottom 22. The sidewalls 24 include a top edge 26 that defines a top opening 28. The main container 12 has an optional pair of wheels 32 coupled to the bottom of the housing 20. The main container 12 also has a mechanical arm engaging bar 34 coupled to the sidewall 24 of the housing 20 located at the front of the housing 20 oppositely disposed from the lid hinge 16 and push handle 18. The main container 12 is configured to hold large quantities of trash or garbage G.

The lid 14 is configured to correspond with the top opening 28 of the main container 12 so as to cover the top opening 28. The lid 14 may include a front lip, flange, overhang, or handle 38 along a front edge 40 oppositely disposed from the lid hinge 16 and push handle 48. Alternatively, the front edge 40 or adjacent area may include a hole or slot 42 therethrough that is shown in phantom lines. The configuration of the lid 14 may vary depending on the manfucturer.

The trash can 10 also includes an elastic, flexible, releasable lid strap 46 extending between the lid 14 and the main container 12. The lid strap 46 has a strap first, upper, or lid portion 48 that is releasably coupled to a strap second, lower, or housing portion 50. The strap lid portion 48 has a lid loop end 52 and an elongated lid strap portion 54. The lid strap portion 54 has a first strap fastener in the form of a first hook and loop type fastener 56 mounted at an end 58 oppositely disposed from lid loop end 52. The strap housing portion 50 has a housing loop end 60 and an elongated housing strap portion 62. The housing strap portion 62 has a second hook and loop type fastener 64 mounted at an end 66 oppositely disposed from housing loop end 60. The first hook and loop type fastener 56 is configured to releasably mate with or be coupled to the second hook and loop type fastener 64. It should be understood that as an alternative to the first strap fastener in the form of hook and loop type fasteners, other types of releasable strap fasteners may also be used, such as snaps, clamps, adhesives, clips, or the like.

The first and second hook and loop type fasteners 56 and 64 may measure approximately ½ to ¾ inches by approximately 1½ inches, although the size may vary depending on the holding strength of the particular fasteners. The size of these hook and loop type fasteners, and their respective fastening components, provides for a disconnection, separation, release or shearing between the first and second hook and loop type fasteners upon a select minimal pulling or releasing force therebetween of approximately 10 pounds of force, i.e., a pulling or releasing force of approximately 10 pounds of force will cause a separation or releasing between the hook and loop type fasteners 56 and 64. The term approximately 10 pounds of force means that the force is within the range of 9.5 to 10.5 pounds of force. While the preferred pulling or releasing force is approximately 10 pounds of force, the minimal releasing force could be within the range of approximately 6 pounds of force and 14 pounds of force. The minimal releasing force should be great enough to prevent premature releasing of the strap lid portion 48 from the strap housing portion 50 during the occurrence of wind, animal interference, or initial tipping of the trash can 10 during the inverting process of the trash can into the garbage truck. However, the minimal releasing force should also be not so great as to maintain the connection between the strap lid portion 48 and the strap housing portion 50 during the complete inverting of the trash can 10, which would prevent the garbage G within the trash can from being emptied into the garbage truck, especially when the trash can has a minimal amount or weight of garbage G therein.

In use, the strap lid portion 48 of the lid strap 46 is coupled to the lid 14 by passing the lid loop end 52 around handle 18, the lid handle 38, or slot 42 and joined back to the lid strap 46. Similarly, the strap housing portion 50 of the lid strap 46 is coupled to the main container 12 by passing the housing loop end 60 around the mechanical arm engaging bar 34 and back through the center or opening of the housing loop end 60. Alternatively, the loop ends may include couplers that allow the ends to be coupled to the lid and/or main container.

Once the strap lid portion 48 and strap housing portion 50 are coupled to the lid 14 and housing 20 respectively, the strap lid portion 48 and strap housing portion 50 are stretched so that the first and second hook and loop type fasteners 56 and 64 may be joined together. The stretching capabilities of the lid strap 46 enables a secure connection therebetween and a holding down of the lid 14 even if the lid 14 is still partially open or not closed all the away against the housing 20 due to the trash can 10 being overloaded and the garbage extending past the top edge 26 of the housing 20. The lid 14 of the trash can 10 is now secured in position to prevent it from being blow open by the wind or opened by animals while awaiting to be lifted by the garbage truck.

During the dumping process by the garbage truck, the trash can 10 is grasped by the mechanical arm of the garbage truck, lifted to a portion wherein the trash can 10 is inverted, and then inverted so as to cause spillage of the garbage from the trash can 10. When the trash can 10 is inverted, the garbage G within the trash can 10 contacts the interior surface of the closed lid 14 wherein the weight of the garbage G upon the lid 14 creates a force upon the lid 14 in a direction to move the lid 14 to its open position. As the size of the force associated with the garbage weight reaches the releasing force associated with the first and second hook and loop fasteners 56 and 64, the strap lid portion 48 disengages or releases from the strap housing portion 50, and the lid 14 is allowed to pivot to its open position allowing the spillage of the garbage G from the housing 20. Thus, the weight of the garbage G is used to decouple or release the strap lid portion 48 from the strap housing portion 50 and thereby allow for the opening of the lid 14.

It should be understood that during the inverting process of the trash can 10, the lid 14 is maintained closed by the lid strap 46 during the initial phase of the inverting, which maintains the garbage G within the trash can 10 so that the garbage G does not get blown away by wind prior to the trash can being near complete inversion.

It should also be understood that the main housing may include a loop, handle, opening or other area to which the lid strap 46 may be coupled as an alternative to the lid handle 38 and/or mechanical arm engaging bar 34.

It is thus seen that a trash can is now provided that includes a release strap to maintain the lid in a closed position. Although the invention has been shown and described in its preferred form, it should be understood that modifications and variations may be made thereto without departure from its spirit and scope as set forth in the following claims.

1. A trash can comprising:
a container having a bottom and sidewalls extending from said bottom to a top edge defining a top opening;
a lid pivotally coupled to said container along a hinge;
a strap lid portion coupled to said lid, said strap lid portion having a first strap fastener, and
a strap housing portion coupled to said container, said strap housing portion having a second strap fastener, said second strap fastener being releasable couplable to said first strap fastener upon the application of a select release force being applied to said first strap fastener.

2. The trash can of claim 1 wherein said strap lid portion is elastic.

3. The trash can of claim 2 wherein said strap housing portion is elastic.

4. The trash can of claim 1 wherein said strap lid portion includes a looped end.

5. The trash can of claim 1 wherein said strap housing portion includes a looped end.

6. The trash can of claim 1 wherein said first strap fastener and said second strap fastener are hook and loop type fasteners.

7. The trash can of claim 1 wherein said first strap fastener is released from said second strap fastener upon a select release force therebetween being in the range of 6 to 14 pounds of force.

8. The trash can of claim 1 wherein said first strap fastener is released from said second strap fastener upon a select release force therebetween being approximately 10 pounds of force.

9. A trash can strap for use with a trash can having a housing and a lid coupled to the housing, the trash can strap comprising:
a strap lid portion having a looped first end and a second end distal said looped first end having a first strap fastener, and
a strap housing portion having a looped first end and a second end distal said looped first end having a second strap fastener, said second strap fastener being releasable couplable to said first strap fastener upon the application of a select release force being applied to said first strap fastener.

10. The trash can of claim 9 wherein said strap lid portion is elastic.

11. The trash can of claim 10 wherein said strap housing portion is elastic.

12. The trash can of claim 9 wherein said first strap fastener and said second strap fastener are hook and loop type fasteners.

13. The trash can of claim 9 wherein said first strap fastener is released from said second strap fastener upon a select release force therebetween being in the range of 6 to 14 pounds of force.

14. The trash can of claim 9 wherein said first strap fastener is released from said second strap fastener upon a select release force therebetween being approximately 10 pounds of force.

15. A trash can comprising:
a container having a bottom and sidewalls extending from said bottom to a top edge defining a top opening;
a lid pivotally coupled to said container along a hinge between a closed position covering said top opening and an open position uncovering said top opening;
a releasable lid strap extending from said lid to said container, said releasable lid strap being releasable upon a minimal select release force strap being applied to said releasable lid strap to allow said lid to pivot to an open position relative to said container.

16. The trash can of claim 15 wherein said releasable lid strap comprises a lid portion coupled to said lid, said strap lid portion having a first strap fastener, and a strap housing portion coupled to said container, said strap housing portion having a second strap fastener, said second strap fastener being releasable couplable to said first strap fastener upon the application of the select release force being applied to said first strap fastener.

17. The trash can of claim 16 wherein said strap lid portion is elastic.

18. The trash can of claim 17 wherein said strap housing portion is elastic.

19. The trash can of claim 16 wherein said first strap fastener and said second strap fastener are hook and loop type fasteners.

20. The trash can of claim 15 wherein said releasable lid strap is released upon the select release force therebetween being in the range of 6 to 14 pounds of force.

21. The trash can of claim 15 wherein said releasable lid strap is released upon the select release force therebetween being approximately 10 pounds of force.
